(19) United States
(12) Patent Application Publication
(10) Pub. No.: US 2024/0151400 A1
(43) Pub. Date: May 9, 2024

(54) Electric Oven

(71) Applicants: Qingdao Genjoy Home Fashion Co., Ltd., Qingdao (CN); QSTOVES INC., Sammamish, WA (US)

(72) Inventor: Xiaohui Wu, Qingdao (CN)

(21) Appl. No.: 18/494,438

(22) Filed: Oct. 25, 2023

(30) Foreign Application Priority Data
Nov. 7, 2022 (CN) 202222954175.9

(51) Int. Cl. F24C 7/06; F24C 7/08; F24C 15/34

(52) U.S. Cl. CPC F24C 7/067; F24C 7/082; F24C 15/34

(57) ABSTRACT

Provided is an electric oven including an oven body and an oven door used for opening and closing the oven body. Heating devices are arranged in an inner upper portion and an inner lower portion of the oven body, respectively. A heat-conducting plate is provided on top of the heating devices located on the lower portion. An outer wall of the oven body is detachably sleeved with a silicon rubber case, and concave-convex textures are arranged on the surface of the silicon rubber case. Supporting legs used for supporting the oven body are arranged at the outer bottom of the oven body. Through holes are configured in positions, corresponding to the supporting legs, on the silicon rubber case, and distal ends of the supporting legs, away from the oven body, pass through the silicon rubber case through the through holes.

### CROSS-REFERENCE TO RELATED APPLICATION(S)

This application claims priority to Chinese Patent Application No. 202222954175.9, filed Nov. 7, 2022, the entire disclosure of which is hereby incorporated by reference.

### TECHNICAL FIELD

The present disclosure relates to the field of kitchen appliances, in particular to an electric oven.

### BACKGROUND

An electric oven is a kind of appliance commonly used for food baking and having a wide range of uses. As baking equipment, the electric oven needs to heat up to work, and a part of the heat produced is transferred to the surface of the oven, so the user is at the risk of scalding. In some instances, thermal insulation mostly relies on the material of the oven, so the thermal insulation effect varies from material to material and is hard to be guaranteed. In addition, when the ovens are used to bake the food by heating the internal space of the oven only, the food is often not fully heated, so it may take a long time for baking, or the food is cooked with unsatisfactory baking effect.

### SUMMARY

According to aspects of the present disclosure, an electric oven is provided, which includes an oven body and an oven door used for opening and closing the oven body, wherein, a group of heating devices are arranged in the upper portion and the lower portion of the interior of the oven body, respectively; a heat-conducting plate is provided on top of the heating devices located in the lower portion; and an outer wall of the oven body is sleeved with a silicon rubber case for preventing scalding.

In some implementations, concave-convex textures are arranged on the surface of the silicon rubber case, supporting legs used for supporting the oven body are arranged at the outer bottom of the oven body, through holes are configured in positions on the silicon rubber case, corresponding to the supporting legs, and the distal ends, away from the oven body, of the supporting legs pass through the silicon rubber case through the through holes.

In some implementations, the heating devices are electric heating tubes, and the heat-conducting plate is a stone plate or a metal plate.

In some implementations, the bottom surface of the heat-conducting plate is in contact with the heating devices located in the lower portion.

In some implementations, the casings of the oven body and the oven door are made of double-layer metal plates, and a thermal insulation material is filled between the two layers of the metal plates.

In some implementations, aluminum silicate is selected as the thermal insulation material.

In some implementations, temperature detecting devices are provided inside the oven body, a power cable and a control panel are provided outside the oven body, the control panel is connected with the heating devices and the temperature detecting devices, and the power cable is connected with the control panel, the heating devices and the temperature detecting devices, respectively.

In some implementations, the supporting legs are foldable, and the ends, closing to the oven body, of the supporting legs are rotatably connected with the oven body.

In some implementations, an internal space of the oven body has a flattened shape, and a width L of the internal space of the oven body is three times (or more) a height S of the internal space of the oven body.

In some implementations, the oven door is provided with a sight window and a handle, the sight window is located at the center of the oven door, and the handle is located up or below the sight window and installed on the side of the oven door, away from the oven body.

According to implementations of the present disclosure, a silicon rubber case is provided, which protects people from being scalded with low thermal conductivity. The concave-convex textures on the surface of the silicon rubber case increase the heat dissipation area, which is beneficial to the heat dissipation of the electric oven surface. Moreover, the supporting legs at the bottom of the oven body are capable of supporting the electric oven to keep a certain distance from the surface where the electric oven is placed, thus further improving the heat dissipation effect and securing the user.

The heating devices and the heat-conducting plate arranged in the present disclosure make the food heated evenly and enhance the baking effect, and the oven body designed in flat structure reduces the baking time and improves the baking efficiency.

The casings of the oven body and the oven door of the present disclosure can be made of double-layer metal plates, and a thermal insulation material is filled between the two layers of the metal plates, so that the oven experiences a sharper increase in internal temperature and an improved thermal insulation performance.

### BRIEF DESCRIPTION OF THE DRAWINGS

FIG. 1 is a schematic diagram showing an example structure of an electronic oven according to implementations of the present disclosure;

FIG. 2 is a schematic diagram showing an example of an internal structure of the electronic oven according to implementations of the present disclosure;

FIG. 3 is a schematic diagram showing an example of the electronic oven after disassembly of the silicon rubber case according to implementations of the present disclosure.

Numerals in the figures: 1—oven body, 2—oven door, 21—handle, 22—sight window, 3—heating device, 4—heat—conducting plate, 5—silicone rubber case, 51—through hole, 6—supporting leg.

### DETAILED DESCRIPTION

In order to make the object, technical solution and advantages of the present disclosure clearer, the present disclosure is further described in detail in combination with the description of drawings and embodiments. It should be understood that specific embodiments or implementations described herein are only used to explain rather than limit the present disclosure.

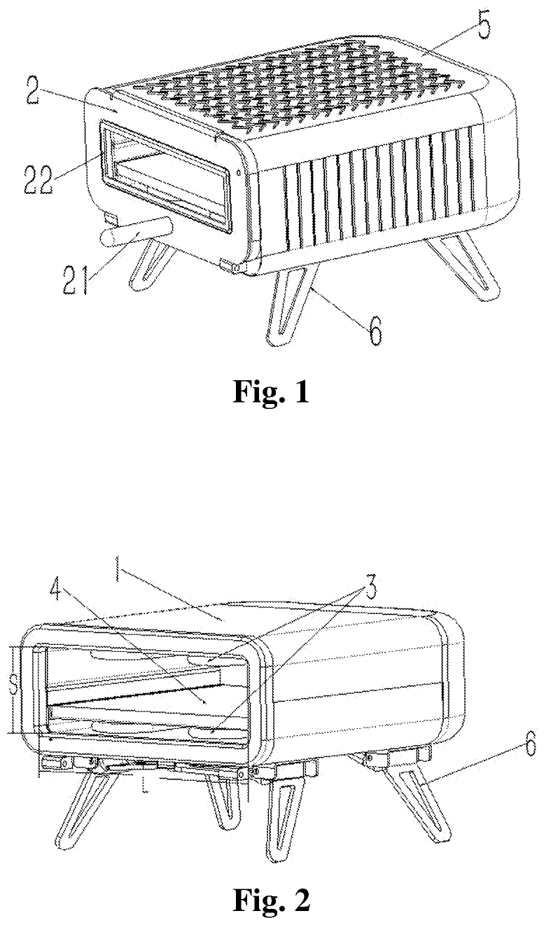

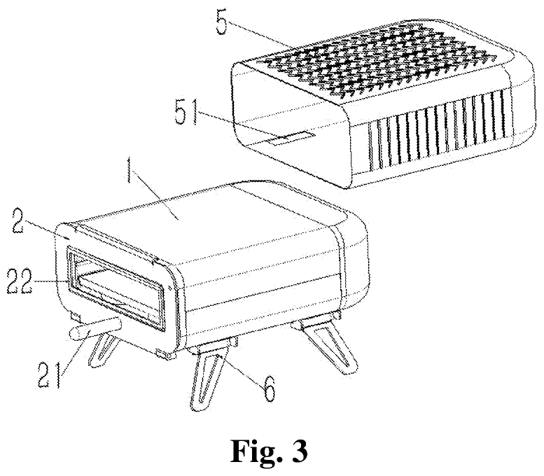

Referring to FIGS. 1-3, an electric oven is provided, including an oven body 1 and an oven door 2 used for opening and closing the oven body 1. Referring to FIG. 2, a group of heating devices 3 are arranged in the upper portion and the lower portion of the interior of the oven body 1, respectively. A heat-conducting plate 4 is provided on top of the heating devices 3 located on the lower portion. Referring to FIGS. 1 and 3, an outer wall of the oven body 1 is sleeved with a silicon rubber case 5, and concave-convex textures are arranged on the surface of the silicon rubber case 5. Supporting legs 6 used for supporting the oven body 1 are arranged at the outer bottom of the oven body 1. Referring to FIG. 3, through holes 51 are configured in positions, corresponding to the supporting legs 6, on the silicon rubber case 5, and the distal ends, away from the oven body 1, of the supporting legs 6 pass through the silicon rubber case 5 through the through holes 51.

Hence, embodiments of the present disclosure aim to provide an electric oven good in heat dissipation effect and food heating. More specifically, the silicon rubber case 5 is resistant to high temperature and heat insulated, which protects people from being scalded. The concave-convex textures on the surface of the silicon rubber case 5 increase the surface area of the silicon rubber case 5, thus further increasing the heat dissipation area of the silicon rubber case 5. When the electric oven is used for prolonged heating, a portion of heat will be transferred to the surface of the oven, and the silicon rubber case 5 with the concave-convex textures plays the role of thermal insulation and dissipates the part of heat gradually to decrease the surface temperature of the oven.

In some implementations, the silicon rubber case 5 is an elastic sleeve, which is designed to match the shape of the outer wall of the oven body 1. The silicon rubber case 5 can be required to be smaller than the oven body 1 in size, so as to avoid the situation that the silicone rubber case 5 becomes loose and prone to fall off from the oven body 1.

The concave-convex textures may be points, lines, patterns, designs and so on.

In some implementations, the heating devices 3 can include electric heating tubes that are used as the heat source of the electric oven. The heat-conducting plate 4 can be made of heat-resistant materials such as a stone plate or a metal plate, which has the characteristics of quick heat conduction and uniform heating.

In some implementations, the bottom surface of the heat-conducting plate 4 is in contact with the heating devices 3 located in the lower portion, so that the heat of the heating devices 3 in the lower portion is directly transferred to the heat-conducting plate 4, and the temperature of the heat-conducting plate 4 is uniformly increased by heating the heat-conducting plate 4. In this way, the food is heated more evenly, and the baking effect is improved.

In some implementations, the casings of the oven body 1 and the oven door 2 can be made of double-layer metal plates, and the metal plates can be made of stainless steel, and a thermal insulation material is filled between the two layers of the double-layer metal plates to form a thermal insulation layer, so that the oven body 1 experiences a sharper increase in internal temperature, with heat not so easily dissipated and thereby achieving an improved thermal insulation performance.

In some implementations, aluminum silicate, also known as ceramic fiber, is selected as the thermal insulation material. Aluminum silicate is non-toxic and odorless, and suitable for being used as the thermal insulation layer of the oven. Other thermal insulation materials with safe properties can also be used, with the goal of achieving guaranteed food safety as well as ensuring the thermal insulation effect.

In some implementations, one or more temperature detecting devices are provided inside the oven body 1, a power cable and a control panel are provided outside the oven body 1, the control panel is connected with the heating devices 3 and the temperature detecting devices, and the power cable is connected with the control panel, the heating devices 3 and the temperature detecting devices, respectively. The control panel is used for turning on/off the oven, and presetting the temperature of the heating tubes and the heating duration, etc.

In some implementations, the supporting legs 6 are foldable, and the proximal ends, close to the oven body 1, of the supporting legs 6 are rotatably connected with the oven body 1. To use the oven, the supporting legs 6 are unfolded to support the oven and keep a certain distance from the surface where the oven is placed to facilitate heat dissipation. After use, the supporting legs 6 may be folded to minimize the space occupied.

In some implementations, an internal space of the oven body 1 has a flattened shape, and a width L of the internal space of the oven body 1 is three times (or more) a height S of the internal space of the oven body 1, so that the baking duration is shortened. In addition, the flattened design of the internal space is suitable for baking pizza, pancake, steak, chicken wings and other flat foods, which are cooked faster than foods in other shapes when using the oven.

In some implementations, as shown in FIGS. 1 and 3, the oven door 2 is provided with a sight window 22 and a handle 21, the sight window 22 is located at the center of the oven door 2, and the handle 21 is installed on the side, away from the oven body 1, of the oven door 2.

According to implementations of the present disclosure, a silicon rubber case is provided, which protects people from being scalded with low thermal conductivity. The concave-convex textures on the surface of the silicon rubber case increase the heat dissipation area, which is beneficial to the heat dissipation of the electric oven surface. Moreover, the supporting legs at the bottom of the oven body are capable of supporting the electric oven to keep a certain distance from the surface where the electric oven is placed, thus further improving the heat dissipation effect and securing the user.

The heating devices and the heat-conducting plate arranged in the present disclosure make the food heated evenly and enhance the baking effect, and the oven body designed in flat structure reduces the baking time and improves the baking efficiency.

The casings of the oven body and the oven door of the present disclosure can be made of double-layer metal plates, and a thermal insulation material is filled between the two layers of the metal plates, so that the oven experiences a sharper increase in internal temperature and an improved thermal insulation performance.

The embodiments and implementations of the present disclosure are described in detail in combination with the description of drawings. It should be understood that only example embodiments of the present disclosure are described above, but the present disclosure is not limited thereto. Any modification and improvement made by those skilled in the art without departing from the spirit of the present disclosure shall be incorporated in the protection scope of the present disclosure.

What is claimed is:

1. An electric oven, comprising an oven body and an oven door for opening and closing the oven body, wherein, heating devices are arranged in an inner upper portion and an inner lower portion of the oven body, respectively; a heat-conducting plate is provided on top of the heating devices located in the inner lower portion of the oven body; and an outer wall of the oven body is sleeved with a silicon rubber case for preventing scalding.

2. The electric oven according to claim 1, wherein concave-convex textures are arranged on a surface of the silicon rubber case, supporting legs are arranged at an outer bottom portion of the oven body for supporting the oven body, through holes are configured in positions on the silicon rubber case corresponding to the supporting legs, and distal ends of the supporting legs away from the oven body pass through the silicon rubber case through the through holes.

3. The electric oven according to claim 1, wherein the heating devices comprise electric heating tubes, and the heat-conducting plate comprises a stone plate or a metal plate.

4. The electric oven according to claim 1, wherein a bottom surface of the heat-conducting plate is in contact with the heating devices located in the inner lower portion of the oven body.

5. The electric oven according to claim 1, wherein the casings of the oven body and the oven door are made of at least two layers of metal plates, and a thermal insulation material is filled between the at least two layers of the metal plates.

6. The electric oven according to claim 5, wherein the thermal insulation material is made of aluminum silicate.

7. The electric oven according to claim 1, wherein a temperature detecting device is provided inside the oven body, a power cable and a control panel are provided outside the oven body, the control panel is connected with the heating devices and the temperature detecting device, and the power cable is connected with the control panel, the heating devices and the temperature detecting device, respectively.

8. The electric oven according to claim 2, wherein the supporting legs are foldable, and proximal ends of the supporting legs close to the oven body are rotatably connected with the oven body.

9. The electric oven according to claim 1, wherein an interior space of the oven body has a flattened shape, and a width of the interior space of the oven body is at least three times a height of the interior space of the oven body.

10. The electric oven according to claim 1, wherein the oven door is provided with a sight window and a handle, and the handle is installed on a side of the oven door away from the oven body.
